(19) United States
(12) Patent Application Publication
(10) Pub. No.: US 2011/0104356 A1
(43) Pub. Date: May 5, 2011

(54) NUT CLUSTER BINDER AND METHOD OF MANUFACTURE

(75) Inventors: Edward C. Coleman, New Fairfield, CT (US); John P. Locke, Hillsdale, NJ (US); Froilan W. Sornoza, Little Falls, NJ (US)

(73) Assignee: KRAFT FOODS GLOBAL BRANDS LLC, Northfield, IL (US)

(21) Appl. No.: 12/609,693

(22) Filed: Oct. 30, 2009

(51) Int. Cl. A23L 1/05; A23J 7/00

(52) U.S. Cl. 426/573; 426/662

(57) ABSTRACT

Compositions and methods for a food binder that, when blended with a solid nut blend, provides a cohesive shelf-stable low water activity product that is chewy and has high lubricity (i.e., not tooth-compacting). One embodiment of a binder composition can have an aqueous based syrup in a range from about 33 to 74 percent weight; sucrose in a range from about 10 to 35 percent weight; polyhydric alcohol in a range from about 2 to 20 percent weight; fat in a range from about 2 to 30 percent weight; and an emulsifier in the range from about 0.5 to 2 percent weight. In a preferred embodiment, the syrup/sucrose:fat:polyhydric alcohol ratio is about 9:3:1 respectively by weight. Also, in a product using the binder, the binder can be in the range of about 25 to 35 percent weight and have an A_{w} less than about 0.35.

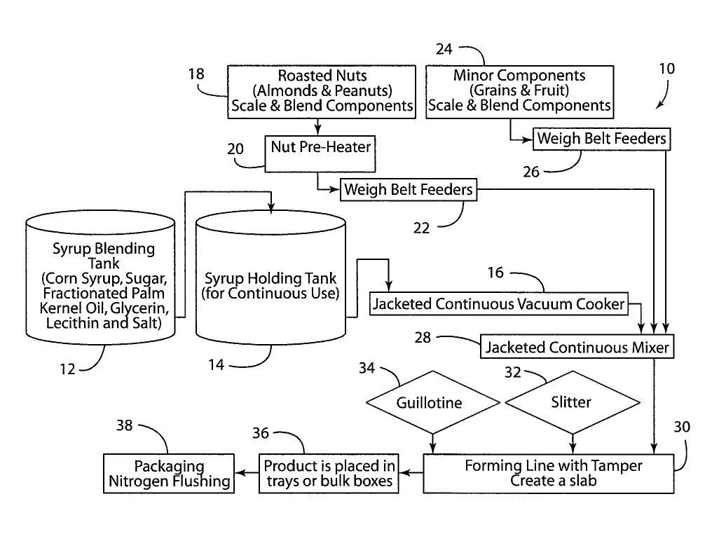

### FIELD

The present products and methods generally relate to food binder compositions, and more particularly, to food binder compositions that, when coated to a solid nut blend, provide a cohesive shelf-stable low water activity product that is chewy and has high lubricity.

### BACKGROUND

Food binding agents are known in the art to add cohesiveness to various types of food product blends. Food product blends can typically include an almost infinite combination of grains, nuts, cereals, granola, dried fruits, seeds, cookie crumbs, pretzels, and the like. Such products can be formed into granola bars, nut clusters, or other types of food bars or snack bars (‘food bars’). Other ingredients can include preservatives, sweeteners, flavorings (including salt and extracts), and the like.

In the past, binding agents for food bars have included various shortening and syrup combinations, such as corn syrup or maple syrup. Product ingredients can be mixed with the binder, then formed into bars or slabs. The final product is typically mixed, formed and/or baked prior to packaging and sale.

Other ingredients and methods are also known for food bars. For example, polyhydric alcohols (a polyol), such as glycerine or sorbitol, can be added to improve cohesiveness, texture, release of product from a mold, as well as provide for a sugar substitute. Polyhydric alcohols can also act as a humectant to lower product moisture. Despite these potential advantages, addition of a polyhydric alcohol can negatively affect product taste.

Improving shelf life of a food bar is also of interest in the art by reducing or eliminating growth of molds, yeasts and bacteria. The reduction or elimination of such microbial growth of a final product can be attempted in many ways. The product can be sterilized, then hermetically sealed or frozen. Product pH can be reduced. Water content can also be lowered. However, these attempts can have disadvantages. Freezing and sterilizing can add significant production costs and alter product taste. Many foods do not tolerate or taste good in a low pH.

Water content of a product, as measured by its water activity (A_{w}), has a significant affect on product shelf life. A_{w} is the partial vapor pressure of water in a product at room temperature. In general, a low A_{w} of about 0.9 percent generally creates an environment in which most bacteria will not grow. Cook et al. (U.S. Pat. No. 4,451,488) discloses a product with reduced sugar and increased polyhydric alcohols, while keeping the A_{w} below 0.55.

Unfortunately, lowering water content can make the product extremely hard and tooth compacting (i.e., a low lubricity, which can cause product to stick in consumer's teeth during consumption). This can be especially true for products containing nut blends.

Also, Linscott (U.S. Pat. No. 4,871,557) discloses a syrup based binder for a food bar (granola) that can include from about 1 to about 10 percent of an edible oil, such as a hydrogenated soybean/cottonseed oil. Preferably, the oil is about 5 percent of the syrup pre-blend and about 2 percent of the final product. Lecithin can be added as an oil emulsifier in an amount of about 0.25 percent of the syrup pre-blend and about 0.1 weight percent of the final product.

Further, Becker, et al. (U.S. Pat. Nos. 4,568,557 and 4,673,578) discloses snack food products including nut blends where a fat portion of about 25 to 55 percent by weight can include coconut oil, palm oil, palm kernel oil, cottonseed oil, safflower oil, sunflower oil, soy oil, corn oil and mixtures thereof. In one embodiment, the fat portion is a combination of about 28 percent fractionated palm kernel oil and about 2 percent hydrogenated palm oil. This product has high fiber and high water activity for extrusion and immediate consumption without baking.

While there have been significant advances in the art, further advances are possible. For example, there is a desire and need in the art to provide a binder composition that provides the viscosity, cohesion, and functional properties of traditional binders for food bars, but with a softer texture that has high lubricity, especially in low A_{w} environments and suitable for use with food products containing nut blends.

### SUMMARY

Accordingly, there is provided herein embodiments and methods of producing compositions generally relating to food binder compositions, and more particularly, to food binder compositions that, when blended with a solid nut blend, provide a cohesive shelf-stable low water activity product that is chewy and has high lubricity (i.e., not tooth-compacting).

One embodiment of a binder composition can have an aqueous based syrup in a range from about 33 to 74 percent weight; sucrose in a range from about 10 to 35 percent weight; polyhydric alcohol in a range from about 2 to 20 percent weight; fat in a range from about 2 to 30 percent weight; and an emulsifier in the range from about 0.5 to 2 percent weight.

In a preferred embodiment, the binder can have 42 to 62 percent weight corn syrup or brown rice syrup or a blend, about 22 percent weight fine grind sucrose, about 6 percent weight glycerin or other polyol, about 2 to 20 percent weight fractionated palm kernel oil, about 1 percent weight lecithin, and less than about 3 percent weight flavors. Flavors can include salt, natural extracts, fruit flavors, chocolate flavors, artificial flavors, caramel flavoring, peanut butter, and the like.

In a preferred embodiment, the syrup/sucrose:fat:polyhydric alcohol ratio is about 9:3:1 respectively, by weight. Also, in a product using the binder, the binder can be in the range of about 25 to 35 percent weight of the total product and have an A_{w} less than about 0.35.

An embodiment of a food product using the described binder can preferably contain a nut blend, but optionally can contain other dry goods such as grains, nuts, cereals, granola, dried fruits, seeds, cookie crumbs, pretzels and combinations thereof.

Methods of making a nut blend product using the binder can include the steps of preblending, storing and cooking the binder in a jacketed continuous cooker at about 75 to 140 degrees Celsius (and preferably at about 132 degrees Celsius); heating a nut blend to a range of about 80 to 110 degrees Celsius; and blending the binder and nut blend in a jacketed continuous mixer until the nut blend is thoroughly coated. Optionally, other minor ingredients can be included such as flavors, grains, nuts, cereals, granola, dried fruits, seeds, cookie crumbs, pretzels and the like.

Additional steps can include tamping the product into a slab after blending the binder and nut blend; cutting the slab to a final product dimension; nitrogen flushing a package; inserting the product; and sealing the product.

Other features will become more apparent to persons having ordinary skill in the art to which pertains from the following description and claims.

### DETAILED DESCRIPTION

The present products and methods generally relate to food binder compositions, and more particularly, to food binder compositions that, when coated to a solid nut blend, provide a cohesive shelf-stable low water activity product that is chewy and has a high lubricity (i.e., not tooth-compacting).

In general, the present products utilize a sugar/fat/polyhydric alcohol blend that can deliver a cluster that retains moistness, stability, cohesiveness and free-flow characteristics at moderate sweetness levels. The present binder can thus provide, for example, a nut cluster product with superior organoleptic and stability characteristics.

As described herein, the binder composition can have a non-sucrose aqueous based syrup in a range from about 33 to 74 percent weight; sucrose in a range from about 10 to 35 percent weight; a polyol such as a polyhydric alcohol in a range from about 2 to 20 percent weight; fat in a range from about 2 to 30 percent weight; and an emulsifier in the range from about 0.5 to 2 percent weight. One preferred embodiment can have 42 to 62 percent weight syrup, about 22 percent weight fine grind sucrose, about 6 percent weight glycerin or other polyol, about 2 to 20 percent weight fractionated palm kernel oil, about 1 percent weight emulsifier, and less than about 3 percent weight flavors.

Any fat exhibiting a melting point similar to palm kernel oil, such as cocoa butter, can also be used. The fat in the binder, provides lubricity and improves moistness throughout the product shelf life. The emulsifier can be a food grade emulsifier such as lecithin, and the like. Flavors can include salt, natural extracts, chocolate, fruit, caramel, and the like. It is noted that an unexpected benefit of the binder composition described herein is the high degree of flavor delivery than would be expected for a product using this binder. The fat/glycerine combination can act to form a barrier or a complex to protect the flavor.

The syrup can be an aqueous based syrup of corn syrup, brown rice syrup, a blend of corn and brown rice syrup, or other blends that can result in a dextrose equivalent (DE) of approximately 42 or 43DE, or even higher. Additionally, a soluble fiber can be added to improve product nutrition, such as inulins, fructooligosaccharides, soluble corn fiber and polydextrose. Fine-grind sucrose can be added to increase solids.

Polyhydric alcohol is a polyol and includes any organic compound having three or more hydroxyl functional groups. The present polyhydric alcohols, such as glycerin, sorbitol, maltitol, mannitol, xylitol or other food grade polyhydric alcohol can serve as a humectant to lower the water activity of the final product. The humectant is introduced in proportion so that when added to the binder and other dry products, such as nut blends, grains, nuts, cereals, granola, dried fruits, seeds, cookie crumbs, pretzels and combinations thereof, the final product water activity (‘A_{w}’) is less than about 0.4 (and preferably less than 0.35) to improve shelf life. It is noted though that some dry ingredients, like some fruits, have higher water content than may be suitable for some types of compositions to maintain the preferred A_{w}.

The binder can be in the range of about 25 to 35 percent of the total product by weight, and preferably around 30 percent by weight. It is also noted that a syrup/sucrose:fat:polyhydric alcohol ratio of 9:3:1 within the binder provides preferred results and “free-flow” characteristics. Nuts coated with this syrup/sucrose:fat:polyhydric alcohol layer have excellent shelf life via oxidative rancidity control of at least nine months at ambient temperatures.

Prior attempts to develop nut cluster products having greater than about 30 percent weight nut blend have resulted in a hard texture and exhibit poor cohesion. In contrast, using the binder described herein, the final product exhibits excellent cohesive properties and texture that is not hard and tooth-compacting. Also, the binder provides an excellent medium for the addition of flavors. Thus, products using the present binder deliver excellent flavor, texture and are free-flowing (no surface stickiness).

Exemplary embodiments of binder formulations can be found in Table 1 that could ultimately compose about 25 to 35 percent weight of the total product. Exemplary embodiments of dry components that could be about 75 to 65 percent weight of the total product to blend with the binder to make a food product can be found in Table 2. In addition to salt, other flavors are possible such as fruit, natural extracts, artificial flavors, chocolate, caramel, peanut butter, and the like.

TABLE 1
Exemplary formulations of the binder

| Ingredients | Binder A | Binder B | Binder C |
|---|---|---|---|
| Corn Syrup 42DE | 42% | 56% | 50% |
| Sugar FG | 42% | 22% | 22% |
| Glycerin | 6% | 6% | 6% |
| FPKO | 6% | 12% | 18% |
| Salt | 3% | 3% | 3% |
| Lecithin | 1% | 1% | 1% |

TABLE 2
Exemplary formulations of the dry components

| Ingredients | Blend A | Blend B | Blend C |
|---|---|---|---|
| Peanuts | 35% | 35% | 35% |
| Almonds | 36% | 36% | 36% |
| Dried Cranberries | 7% | | |
| Dried Raisins | 5% | | |
| Crisp Rice | 6% | | 9% |
| Granola | 10% | | 20% |
| Chocolate Granola | | 20% | |
| Cocoa Crisp | | 9% | |

Turning now to the Figure, there is shown a method of manufacturing a food product using the binder described herein and is generally indicated at 10. The binder preparation can include heating the syrup to approximately 80 degrees Celsius then adding in the other binder ingredients, such as additional sugars, fat, flavors, emulsifiers in a pre-cooker mixing tank 12. Next, the binder blend can be sent to a holding tank 14 for continuous use. The binder can then be pumped to a heat exchanger/evaporator 16, such as a jacketed continuous vacuum cooker, and heated to a range of about 75 to 140 degrees Celsius. Preferably, at this step the binder is heated to about 132 degrees Celsius.

The high heating of the binder is possible since dry goods such as nuts tolerate higher temperatures than typical food bars composed of mostly grain or fruit pieces. This adds several product advantages. A higher binder temperature allows improved flow. The high temperature also flashes out some of the moisture in the dry products to achieve the low A_{w}. Nevertheless, given a specified amount of fat, the product retains a softer character than would be expected with high heat binders mixed with grains where the sugar can crystallize and become very hard. The high temperature may also caramelize some of the sugar component providing an added flavor benefit. Temperature range can be adjusted and water can be added at this step as needed to maintain a final product A_{w} of less than 0.4 and preferably less than 0.35.

The nut blend can be scaled and blended at component 18. The resulting nut blend can be heated to about 80 to 110 degrees Celsius in a nut pre-heater 20. Other dry goods can be scaled and blended at component 24. The nut blend can be delivered to a product mixer 28 via a nut blend weigh belt feeder 22. The remaining dry goods can be delivered to product mixer 28 via a second weigh belt feeder 26. The binder is also pumped into product mixer 28. Product mixer 28 can be a jacketed continuous mixer and mix the binder and dry goods until the dry goods are thoroughly blended. Usually this would take approximately 10 to 60 seconds to complete. At this step, water can be added to adjust to final desired water activity.

From product mixer 28, the product can be delivered to a forming line 30, where the product blend can be formed into a product slab using, for example, a tamper. As the product blend cools to about 50 to 60 degrees Celsius, the product slab can be cut into final desire product dimensions, such as 2.5 by 2.5 cms, using a slitter 32 and a guillotine 34.

At step 36, the final product can be placed into trays or other containers to allow further cooling. And, at step 38, the final product can be placed and sealed into a nitrogen flushed package. The packaging can be, but is not required to be, impervious to water.

While the products and methods have been described in conjunction with specific embodiments, it is evident that many alternatives, modifications, and variations will be apparent to those skilled in the art in light of the foregoing description.

We claim:

1. A food binder pre-blend for a food bar, comprising:
a non-sucrose aqueous based syrup in a range from about 33 to 74 percent weight;
sucrose in a range from about 10 to 35 percent weight;
polyhydric alcohol in a range from about 2 to 20 percent weight;
fat in a range from about 2 to 30 percent weight; and
an emulsifier in the range from about 0.5 to 2 percent weight.

2. The food binder of claim 1, wherein:
the syrup is in a range from about 42 to 62 percent weight;
the sucrose is about 22 percent weight fine grind sucrose;
the polyhydric alcohol is about 6 percent weight;
the fat is in a range from about 2 to 20 percent weight; and
the emulsifier is about 1 percent weight.

3. The food binder of claim 1, wherein the syrup is selected from the list consisting of corn syrup, brown rice syrup, and a blend thereof.

4. The food binder of claim 1, wherein the emulsifier is lecithin.

5. The food binder of claim 1, wherein the polyhydric alcohol is glycerin.

6. The food binder of claim 1, wherein the fat is approximately 12 percent weight fractionated palm kernel oil.

7. The food binder of claim 1, further comprising about less than 3 percent weight flavoring.

8. The food binder of claim 7, wherein flavoring is selected from the list consisting of fruit, natural extracts, artificial flavors, chocolate, caramel and peanut butter.

9. The food binder of claim 1, wherein the syrup/sucrose:fat:polyhydric alcohol ratio is about 9:3:1 respectively by weight.

10. A food product comprising a binder according to claim 1 in the range of about 25 to 35 percent weight.

11. The food product of claim 10, wherein the binder is about 30 percent weight.

12. The food product of claim 10, wherein the A_{w} is less than about 0.35.

13. The food product of claim 10, further comprising a nut blend.

14. The food product of claim 10, further comprising components selected from the list of grains, nuts, cereals, granola, dried fruits, seeds, cookie crumbs, pretzels and combinations thereof.

15. A method of making the food product of claim 10, including the steps of:
preblending, storing and cooking the binder in a jacketed continuous cooker at about 75 to 140 degrees Celsius;
heating a nut blend to a range of about 80 to 110 degrees Celsius; and
blending the binder and nut blend in a jacketed continuous mixer until the nut blend is thoroughly coated.

16. The method of claim 15, wherein the binder is heated to about 132 degrees Celsius.

17. The method of claim 15, wherein the blending of the binder and nut blend is in the range of about 10 to 60 seconds.

18. The method of claim 15, further comprising the step of adding minor ingredients selected from the list consisting of flavors, grains, nuts, cereals, granola, dried fruits, seeds, cookie crumbs and pretzels to the jacketed continuous mixer.

19. The method of claim 15, further comprising the steps of:
tamping the product into a slab after blending the binder and nut blend; and
cutting the slab to a final product dimension.

20. The method of claim 19, further comprising the steps of:
nitrogen flushing a package;
inserting the product; and
sealing the product.
